(19) United States
(12) Patent Application Publication
(10) Pub. No.: US 2026/0043695 A1
(43) Pub. Date: Feb. 12, 2026

(54) STRAIN-GAUGE AUTO-ZERO WITHOUT USING ROTATIONAL ANGLE

(71) Applicant: 4IIII INNOVATIONS INC., Cochrane, Alberta (CA)

(72) Inventor: Arthur William HARE, Kitchener, Ontario (CA)

(21) Appl. No.: 19/139,948

(22) PCT Filed: Dec. 13, 2023
(86) PCT No.: PCT/IB2023/000773

§ 371 Date: Jun. 17, 2025

Related U.S. Application Data
(60) Provisional application No. 63/433,513, filed on Dec. 19, 2022.

(51) Int. Cl. G01L 1/22; B62J 45/41; B62J 45/421

(52) U.S. Cl. CPC G01L 1/2268; B62J 45/41; B62J 45/421

(57) ABSTRACT

A power meter has a strain-gauge attached to a crank of a pedaled vehicle to measure a bend force applied to the crank. The power meter also includes an accelerometer positioned on the crank to sense a Y-axis acceleration. The power meter also includes a controller having a processor and memory storing machine-readable instructions that when executed by the processor cause the controller to: read a bend force value from the strain-gauge, read an accelerometer value from the Y-axis accelerometer, calculate a correction factor based on the accelerometer value and a maximum error force value, and subtract the correction factor from the bend force value to determine an auto-zero bend force value that is corrected for an effect of gravity on the crank.

### RELATED APPLICATION

This application claim priority to U.S. Patent Application No. 63/433,513, titled “Strain-Gauge Auto-Zero Without Using Rotational Angle,” filed Dec. 19, 2022, and incorporated herein by reference in its entirety.

### BACKGROUND

A power-meter attached to a bicycle crank uses strain-gauges to measure force applied to the crank and therefrom determine power generated by a cyclist. However, as the crank rotates through 360 degrees, the mass of the pedal and crank apples torque to the strain-gauges and thereby introduces a force that is not caused by the cyclist. When the crank is at 3 o'clock (pointing to the front of the bicycle), its mass adds to the torque measured by the strain-gauges; when the crank is at 9 o'clock (pointing to the rear of the bicycle) its mass subtracts from the torque measured by the strain-gauges. The resulting force offset may be as much as +/−1.5 Nm and account for 15 W worth of power at regular riding cadences.

A known solution for compensating for this force uses an accelerometer of the power-meter to detect X and Y accelerations affecting the crank, determine an angle (e.g., orientation) of the crank based on the X and Y accelerations, and then apply a correction factor to the strain-gauge measurements based on the angle.

### SUMMARY

Certain aspects of the present embodiments include the realization that conventional power meters calculate the angle of the crank to apply a correction for the effects of gravity on power measurements made by strain-gauges. The present embodiments improve on the conventional power calculations by auto-zeroing strain-gauge outputs to counter the effect of gravity without calculating the angle of the crank. Further, the accuracy of the power measurement derived from the grain gauge is improved since angular errors that occur when calculating the crank angle are avoided.

In certain embodiments, the techniques described herein relate to a power meter for a pedaled vehicle, including: a strain-gauge for sensing a bend force applied to a crank of the pedaled vehicle; a Y-axis accelerometer for sensing a Y-axis acceleration relative to the crank; and a controller having a processor and memory storing machine-readable instructions that when executed by the processor cause the controller to: read a bend force value from the strain-gauge; read an accelerometer value from the Y-axis accelerometer; calculate a correction factor based on the accelerometer value and a maximum error force value; and determine an auto-zero bend force value that is corrected for an effect of gravity on the crank by subtracting the correction factor from the bend force value.

In certain embodiments, the techniques described herein relate to a strain-gauge auto-zero method for determining a correction factor for a bend axis of crank of a pedal powered vehicle that corrects for an error force caused by mass of the crank and a pedal, including: capturing, from a strain-gauge, a bend force value indicative of a force applied to the crank; capturing an accelerometer value from a Y-axis accelerometer; calculating the correction factor based on the accelerometer value and a maximum error force value; and determining an auto-zero bend force value by subtracting the correction factor from the bend force value.

### BRIEF DESCRIPTION OF THE FIGURES

FIG. 1 is a schematic illustrating one example crank fitted with a power-meter that includes an accelerometer package with an X-axis accelerometer (parallel to crank) and a Y-axis accelerometer (orthogonal to crank), in embodiments.

FIG. 2 is a block diagram showing the power-meter of FIG. 1 in further example detail, in embodiments.

FIG. 3 is a graph showing one example output from Y-axis accelerometer as crank rotates around crank bearing, in embodiments.

FIG. 4 is a flowchart illustrating one example method for determining a correction factor for a bend axis of crank of a pedal powered vehicle to correct for an error force caused by mass of the crank and a pedal during rotation of the crank, in embodiments.

### DETAILED DESCRIPTION OF THE EMBODIMENTS

U.S. Pat. Nos. 10,060,738 and 11,033,217, each incorporated herein by reference in its entirety, disclose power and cadence meters for a bicycle.

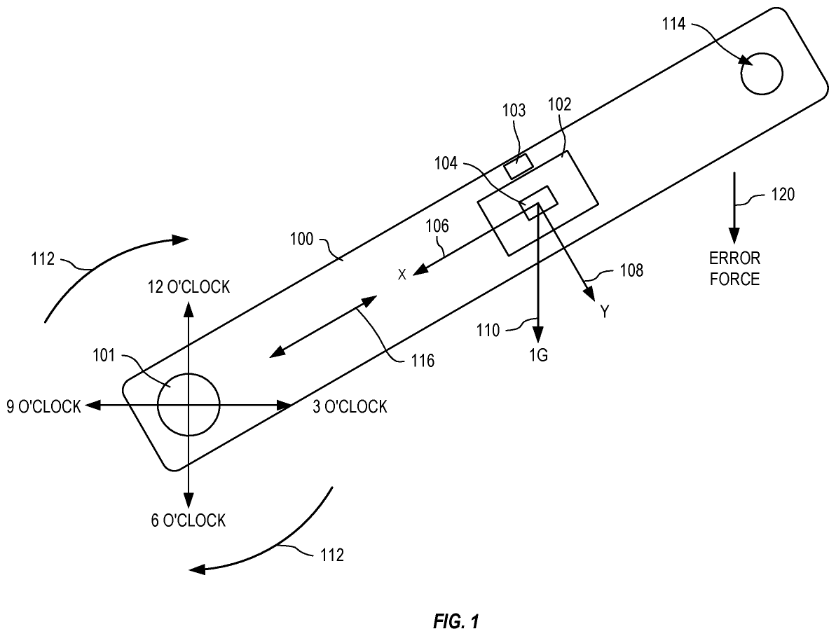

FIG. 1 is a schematic side view illustrating one example crank 100 fitted with a power-meter 102 that includes at least one strain-gauge 103 and an accelerometer package 104 with at least a Y-axis accelerometer 108, where the Y-axis is orthogonal to a length direction 116 of crank 100 and parallel to a rotational plane, indicated by arrows 112, of crank 100. Crank 100 is used to power a pedal powered vehicle, such as a bicycle for example, where crank 100 rotates, as indicated by arrows 112, around a crank bearing 101 to drive the vehicle forwards. A pedal (not shown for clarity of illustration) attaches at aperture 114. Accelerometer package 104 may also include an X-axis accelerometer 106, where the X-axis is parallel to length direction 116 of crank 100, and a Z-axis accelerometer (not shown) that is orthogonal to both X-axis accelerometer 106 and Y-axis accelerometer 108. Accelerometer package 104 cannot distinguish between acceleration and gravity, and continuously detects Earth's gravity.

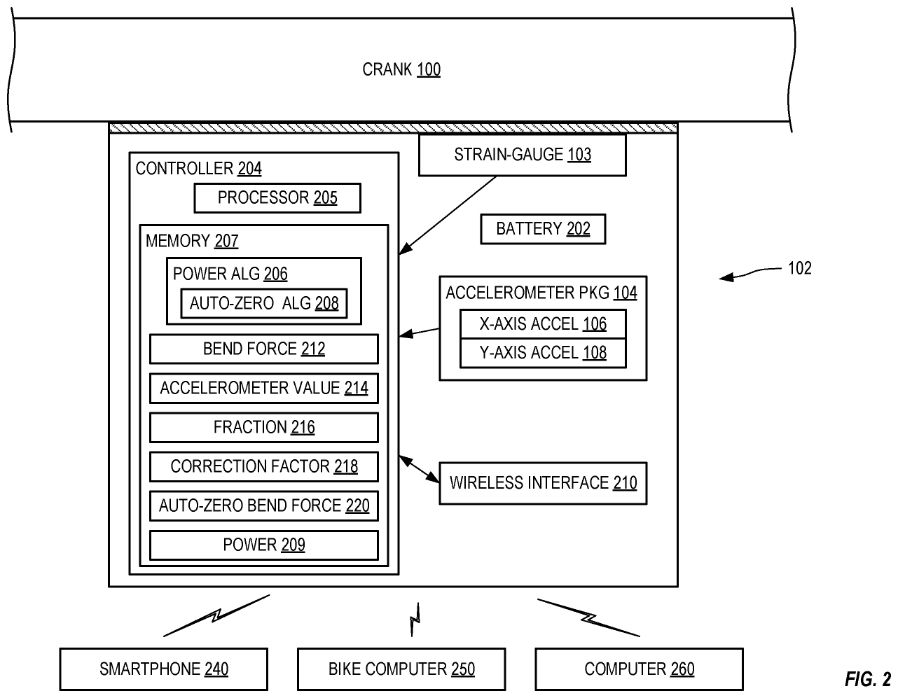

FIG. 2 is a block diagram showing power-meter 102 of FIG. 1 in further example detail. Power-meter 102 includes a battery 202 (optionally rechargeable), a controller 204 (e.g., a microprocessor, microcontroller, ASIC, etc.), strain-gauge 103, accelerometer package 104, and a wireless interface 210. Power-meter 102 may include other sensors and components without departing from the scope hereof. Controller 204 includes a processor 205 and memory 207 storing machine-readable instructions that are executable by processor 205 to implement fictionality described herein. Controller 204 may also include at least one analog to digital converter to digitize analog signals for storing in memory 207 and for processing by processor 205. Controller 204 also includes a power algorithm 206, stored in memory 207, that when executed by processor 205 cause controller 204 to determine power 209 input to crank 100 by a user based on inputs captured from strain-gauge 103 and inputs captured from at least Y-axis accelerometer 108. Power algorithm 206 further includes an auto-zero algorithm 208 that corrects for the effect of gravity on crank 100 as sensed by strain-gauge 103 without determining an angle of crank 100. The following pseudocode provides one example of auto-zero algorithm 208:

$$bend = readStrain ( ) \cdot bend$$

$$accelY = readAccelerometer ( ) \cdot y$$

$$accelY / = ACCELEROMETER\_COUNTS \_PER \_G$$

$$bend -= accelY * PEDALPLUSCRANK\_AT \_ 3 OCLOCK$$

Accordingly, bend is corrected such that power calculations using bend are more accurate than where correction is not applied and the correction calculation is more efficient as compared to prior art corrections that require crank angle. In one example of operation, power algorithm 206 determines power 209 at intervals (e.g., 1/26^{th} of a second) and thereby repeatedly captures readings from both strain-gauge 103 and y-axis accelerometer 108 with crank 100 at different positions as it rotates around crank bearing 101. Advantageously, auto-zero algorithm 208 calculates auto-zero bend force value 220 without requiring the angle of crank 100 to be determined, thereby simplifying functionality within controller 204.

Controller 204 controls wireless interface 210 to communicate with one or more of a smartphone 240, a bike computer 250, and another computer 260. Power algorithm 206 may also determine cadence as part of determining power and work performed by the user, where cadence, also referred to as pedaling rate, is a measurement of the number of revolutions of crank 100 per minute. Cadence is a measure of angular speed that is proportional to but not the same as wheel speed. Cadence and auto-zero bend force value 220 and then used, at least in part, to calculate power applied to crank 100 by the user.

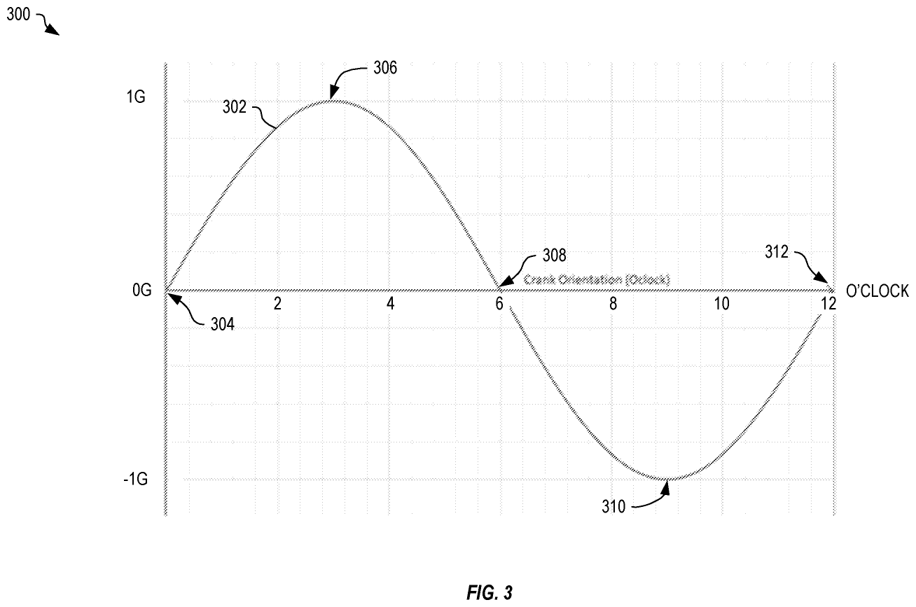

FIG. 3 is a graph 300 showing one example output 302 from Y-axis accelerometer 108 as crank 100 rotates around crank bearing 101. FIGS. 1, 2, and 3 are best viewed together with the following description.

As crank 100 rotates, accelerometer package 104, and thus X-axis accelerometer 106 and Y-axis accelerometer 108 rotate with crank 100. Thus, orientation of X-axis accelerometer 106 and Y-axis accelerometer 108 change with respect to Earth's gravity 110. Accordingly, as crank 100 rotates, X-axis accelerometer 106 and Y-axis accelerometer 108 simultaneously sense Earth's gravity 110 and output accelerometer values in the form of a cosine wave and a sine wave, respectively, because their orientation relative to each other is ninety-degrees. As shown in graph 300, output 302 (e.g., a Y-axis acceleration) from Y-axis accelerometer 108 is zero at 12 o'clock position 304, is 1 G at 3 o'clock position 306, is 0 G at 6 o'clock position 308, is −1 G at 9 o'clock position 310, and returns to 0 G at 12 O'clock position 312. Although not shown, an accelerometer value from X-axis accelerometer 106 is 1 G at 12 o'clock and is −1 G at 6 o'clock. Plotting (X, Y) accelerometer values results in a circle as crank 100 rotates around crank bearing 101.

Strain-gauge 103 may represent one or more strain-gauges strategically positioned on crank 100 to sense force applied to crank 100 by the user. However, crank 100 (and connected pedal, not shown) has an effective mass that applies an error force 120 (e.g., gravitational based force based on the mass of crank 100 and its pedal) to crank 100, causing the output of strain-gauge 103 to include error force 120 that is not attributable to power applied by the user. Conventionally, to compensate for the error force, a prior-art power-meter would determine an angle of the crank and apply a correction factor based on the determined angle to compensate for error force 120. Unlike conventional correction calculations, power-meter 102 uses only an accelerometer value from Y-axis accelerometer 108 to determine the correction factor without determining an angle of crank 100 (angle cannot be determined from accelerometer values from a single axis). For example, a crank at 45 degrees in an elevator accelerating up at 0.3 g experiences the same Y-axis reading (e.g., 1.0 g) corresponding to the error force 120 as a stationary crank at 90 degrees. Similarly, without accelerometer values from X-axis accelerometer 106, power-meter 102 cannot determine whether crank 100 is pointing forward at 45 degrees or rearward at 45 degrees. Without being able to distinguish between forward and rearward positions of crank 100, power-meter 102 cannot apply a correction factor to all possible strain sensing elements. Bend and axial loads grow proportionally to the sensed gravity, but shear loads do not.

One aspect of the present embodiments includes the realization that the correction factor amount (e.g., zero-offset adjustment) required on the bend axis is proportional to the accelerometer value sensed by Y-axis accelerometer 108, which corresponding to Earth's gravity 110. This is because, on a stationary bicycle, Y-axis accelerometer 108 detects “how much gravity is pulling the crank sideways,” which is the value needed to apply a correction to the bend and axial strain-gauge axes. Thus, assuming that the bicycle is stationary, the fraction of 1 G that Y-axis accelerometer 108 is sensing is also the fraction of a maximum error force (e.g., error force 120) being applied to crank 100, and thus the same fraction may be applied to the maximum error force to calculate a correction factor 218 (e.g., a BendAdjust value) to automatically correct bend force value 212 to make power 209 more accurate without calculating the crank angle.

Accordingly, correction factor 218 to correct for error force 120 is determined by the equation:

$$BendAdjust = ( YAccelerationInGs ) * TorqueOfCrankAt 3 OClock$$

where BendAdjust is the correction factor and TorqueOfCrankAt3OClock is error force 120 when crank 100 is at 3 o'clock position (e.g., the maximum error force). In certain embodiments, a calibration procedure is used to determine the maximum error force, where crank 100 is positioned at 3 o'clock and a value is read from strain-gauge 103. Advantageously, controller 204 is not required to determine an angle of crank 100 to make this correction, no angle is used in the calculation, and no lookup table is required to determine correction factor 218 (e.g., BendAdjust).

Table 1 Example Calculation Values is not a lookup table used within power-meter 102, rather, it is provided to show calculated correction factors for a variety of positions of crank 100. In this example, an applied user force has a value of 10,000 (e.g., a reading of strain-gauge 103) measured on a bend axis of crank 100, and the maximum a crank plus pedal weight applied error force 120 has a maximum error offset value of 1500 on the measured bend axis of crank 100.

TABLE 1
Example Calculation Values

| | | | | Bend Reading |
|---|---|---|---|---|
| Crank | Bend | | | minus |
| orientation | Reading | Y Axis | Adjustment | Adjustment |
| (clock angle) | Value | [G] | Amount | Amount |
| 12 o'clock | 10,000.00 | 0.00 | 0.00*1500 | 10000 |
| 1 o'clock | 10,750.00 | 0.50 | 0.50*1500 | 10000 |
| 2 o'clock | 11,299.04 | 0.87 | 0.87*1500 | 10000 |
| 3 o'clock | 11,500.00 | 1.00 | 1.00*1500 | 10000 |
| 4 o'clock | 11,299.04 | 0.87 | 0.87*1500 | 10000 |
| 5 o'clock | 10,750.00 | 0.50 | 0.50*1500 | 10000 |
| 6 o'clock | 10,000.00 | 0.00 | 0.00*1500 | 10000 |
| 7 o'clock | 9,250.00 | −0.50 | −0.50*1500 | 10000 |
| 8 o'clock | 8,700.96 | −0.87 | −0.87*1500 | 10000 |
| 9 o'clock | 8,500.00 | −1.00 | −1.00*1500 | 10000 |
| 10 o'clock | 8,700.96 | −0.87 | −0.87*1500 | 10000 |
| 11 o'clock | 9,250.00 | −0.50 | −0.50*1500 | 10000 |

As shown by Table 1 Example Calculation Values, the G force measured by Y-axis accelerometer 108 may be used to correctly determine an adjustment amount (e.g., correction factor 218—BendAdjust) to correct a measured bend force value 212 for error force 120 caused by weight of crank 100 (and its pedal) for any given position of crank 100 without determining the angle of crank 100. Advantageously, the calculations within power algorithm 206 are simplified, which may provide a further power saving.

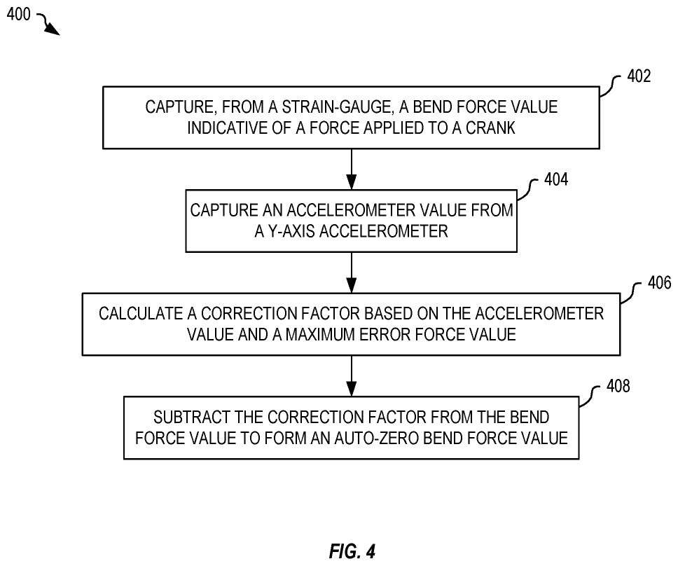

FIG. 4 is a flowchart illustrating one example method 400 for determining a correction factor for a bend axis of crank of a pedal powered vehicle to correct for an error force caused by mass of the crank and a pedal. Method 400 is implemented in power algorithm 206, and at least in part in auto-zero algorithm 208 of FIG. 2, for example.

In block 402, method 400 captures, from a strain-gauge, a bend force value indicative of a force applied to a crank. In one example of block 402, power algorithm 206 reads strain-gauge 103 to determine bend force value 212.

In block 404, method 400 captures an accelerometer value from a Y-axis accelerometer. In one example of block 404, power algorithm 206 reads accelerometer value 214 from Y-axis accelerometer 108.

In block 406, method 400 calculates a correction factor based on the accelerometer value and a maximum error force value. In one example of block 406, power algorithm 206 invokes auto-zero algorithm 208 to calculate a fraction 216 by dividing accelerometer value 214 by a value corresponding to a 1 G force sensed by the accelerometer, and then to calculate correction factor 218 by multiplying a maximum error force value by fraction 216.

In block 408, method 400 subtracts the correction factor from the bend force value to form an auto-zero bend force value. In one example of block 408, power algorithm 206 subtracts correction factor 218 from bend force value to determine an auto-zero bend force value 220.

Accordingly, power algorithm 206 improved the quality of calculated power 209 by using auto-zero bend force value 220 with any need to determine an angle of crank 100 to calculate the adjustment.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

### Combination of Features

Features described above as well as those claimed below may be combined in various ways without departing from the scope hereof. The following enumerated examples illustrate some possible, non-limiting combinations:

(A1) A power meter for a pedaled vehicle, including: a strain-gauge for sensing a bend force applied to a crank of the pedaled vehicle; a Y-axis accelerometer for sensing a Y-axis acceleration relative to the crank; a controller having a processor and memory storing machine-readable instructions that when executed by the processor cause the controller to: read a bend force value from the strain-gauge; read an accelerometer value from the Y-axis accelerometer; calculate a correction factor based on the accelerometer value and a maximum error force value; and determine an auto-zero bend force value that is corrected for an effect of gravity on the crank by subtracting the correction factor from the bend force value.

(A2) In embodiments of (A1), the maximum error force value corresponds to an error force sensed by the strain-gauge when the crank is at 3 o'clock.

(A3) In either of embodiments (A1) or (A2), the Y-axis acceleration is orthogonal to a length direction of the crank and parallel to a plane of rotation of the crank.

(A4) In any of embodiments (A1)-(A3), the memory further storing machine-readable instructions that when executed by the processor cause the controller to: calculate a fraction by dividing the accelerometer value by a value corresponding to 1 G; and calculate the correction factor by multiplying the maximum error force value by the fraction.

(A5) In any of embodiments (A1)-(A4), the memory further storing machine-readable instructions that when executed by the processor cause the controller to calculate a power input to the crank based on the auto-zero bend force value.

(A6) In any of embodiments (A1)-(A5), the memory further storing machine-readable instructions that when executed by the processor cause the controller to repeat, at intervals, the reading, calculating, and subtracting to determine the auto-zero bend force value at any position of the crank as it rotates to drive the pedaled vehicle.

(A7) In any of embodiments (A1)-(A6), the auto-zero bend force value is determined without determining an angle of the crank.

(B1) A strain-gauge auto-zero method for determining a correction factor for a bend axis of crank of a pedal powered vehicle that corrects for an error force caused by mass of the crank and a pedal, including: capturing, from a strain-gauge, a bend force value indicative of a force applied to the crank; capturing an accelerometer value from a Y-axis accelerometer; calculating the correction factor based on the accelerometer value and a maximum error force value; and determining an auto-zero bend force value by subtracting the correction factor from the bend force value.

(B2) In embodiments of (B1), the steps of capturing and calculating being repeated at intervals as the crank is rotated to drive the pedal powered vehicle.

(B3) In either of embodiments (B1) or (B2), the auto-zero bend force is determined without calculating an angle of the crank.

(B4) In any of embodiments (B1)-(B3), in the step of capturing the bend force value, the strain-gauge being attached to the crank at a position to sense bending of the crank.

(B5) In any of embodiments (B1)-(B4), further comprising calculating a power input to the crank based at least in part on the auto-zero bend force value.

(B6) In any of embodiments (B1)-(B5), in the step of capturing the accelerometer value, the Y-axis accelerometer being positioned on the crank to sense acceleration orthogonal to a length direction of the crank and parallel to a rotational plane of the crank.

(B7) In any of embodiments (B1)-(B6), the maximum error force value corresponding to the error force sensed by the strain-gauge when the crank is at 3 o'clock and no other forces are applied to the crank.

(B8) In any of embodiments (B1)-(B7), the calculating comprising: calculating a fraction by dividing the accelerometer value by a value 1 G; and calculating the correction factor by multiplying the maximum error force value by the fraction.

What is claimed is:

1. A power meter for a pedaled vehicle, comprising:
a strain-gauge for sensing a bend force applied to a crank of the pedaled vehicle;
a Y-axis accelerometer for sensing a Y-axis acceleration relative to the crank; and
a controller having a processor and memory storing machine-readable instructions that when executed by the processor cause the controller to:
read a bend force value from the strain-gauge;
read an accelerometer value from the Y-axis accelerometer;
calculate a correction factor based on the accelerometer value and a maximum error force value; and
determine an auto-zero bend force value that is corrected for an effect of gravity on the crank by subtracting the correction factor from the bend force value.

2. The power meter of claim 1, wherein the maximum error force value corresponds to an error force sensed by the strain-gauge when the crank is at 3 o'clock.

3. The power meter of claim 1, wherein the Y-axis acceleration is orthogonal to a length direction of the crank and parallel to a plane of rotation of the crank.

4. The power meter of claim 1, the memory further storing machine-readable instructions that when executed by the processor cause the controller to:
calculate a fraction by dividing the accelerometer value by a value corresponding to 1 G; and
calculate the correction factor by multiplying the maximum error force value by the fraction.

5. The power meter of claim 1, the memory further storing machine-readable instructions that when executed by the processor cause the controller to calculate a power input to the crank based on the auto-zero bend force value.

6. The power meter of claim 5, the memory further storing machine-readable instructions that when executed by the processor cause the controller to repeat, at intervals, the reading, calculating, and subtracting to determine the auto-zero bend force value at any position of the crank as it rotates to drive the pedaled vehicle.

7. The power meter of claim 6, wherein the auto-zero bend force value is determined without determining an angle of the crank.

8. A strain-gauge auto-zero method for determining a correction factor for a bend axis of crank of a pedal powered vehicle that corrects for an error force caused by mass of the crank and a pedal, comprising:
capturing, from a strain-gauge, a bend force value indicative of a force applied to the crank;
capturing an accelerometer value from a Y-axis accelerometer;
calculating the correction factor based on the accelerometer value and a maximum error force value; and
determining an auto-zero bend force value by subtracting the correction factor from the bend force value.

9. The strain-gauge auto-zero method of claim 8, the steps of capturing and calculating being repeated at intervals as the crank is rotated to drive the pedal powered vehicle.

10. The strain-gauge auto-zero method of claim 9, wherein the auto-zero bend force is determined without calculating an angle of the crank.

11. The strain-gauge auto-zero method of claim 8, in the step of capturing the bend force value, the strain-gauge being attached to the crank at a position to sense bending of the crank.

12. The strain-gauge auto-zero method of claim 8, further comprising calculating a power input to the crank based at least in part on the auto-zero bend force value.

13. The strain-gauge auto-zero method of claim 8, in the step of capturing the accelerometer value, the Y-axis accelerometer being positioned on the crank to sense acceleration orthogonal to a length direction of the crank and parallel to a rotational plane of the crank.

14. The strain-gauge auto-zero method of claim 8, the maximum error force value corresponding to the error force sensed by the strain-gauge when the crank is at 3 o'clock and no other forces are applied to the crank.

15. The strain-gauge auto-zero method of claim 8, the calculating comprising:
calculating a fraction by dividing the accelerometer value by a value 1 G; and
calculating the correction factor by multiplying the maximum error force value by the fraction.
